(19) United States
(12) Patent Application Publication
(10) Pub. No.: US 2007/0103438 A1
(43) Pub. Date: May 10, 2007

(54) Charging device and its charging method of self-moving type of mouse

(76) Inventor: Su-Miao Liu, Jiji Township (TW)

Correspondence Address: TROXELL LAW OFFICE PLLC, SUITE 1404, 5205 LEESBURG PIKE, FALLS CHURCH, VA, 22041, US

(21) Appl. No.: 11/305,007

(22) Filed: Dec. 19, 2005

(30) Foreign Application Priority Data
Nov. 7, 2005 (TW) 94139000

(51) Int. Cl. G09G 5/08

(52) U.S. Cl. 345/163

(57) ABSTRACT

A charging device and its charging method of self-moving type of mouse is disclosed. The method comprises the following steps: Step (a): providing a wireless mouse and a charging device, wherein the wireless mouse comprises a base, a displacement-detecting portion positioned on the base, a moving portion capable of stretching out of the base, and a transceiving portion connected to a charging battery. Step (b): Placing the wireless mouse and the charging device on a plane. Step(c): Having the displacement-detecting portion detect whether the wireless mouse is in action or not. Step (d): If the wireless mouse is in action, then, after the displacement-detecting portion acquires a displacement signal with respect to the plane, repeat Step (c); after the wireless mouse stops action for a predetermined time, let the moving portion stretch out of the base. Step (e): Having the moving portion in action, and let the wireless mouse perform a number of sets of predetermined displacement motion. Step (f): The wireless mouse moves to the charging device. Step (g): The transceiving portion (15) performs matching connection with the charging device; Step (h): Performing charging to the charging battery.

### BACKGROUND OF THE INVENTION

1. Field of the Invention

The invention relates to a charging device and its charging method of self-moving type of mouse, and more particularly, to a charging device and its charging method of self-moving type of mouse that is capable of searching for the position of charging device and performing combined charging.

2. Description of the Prior Art

Science and technology changes with each passing days. Ever since the industrial revolution and after the mid-twentieth century, the invention of computer brings forth a deep and long-lasting influence for the human being and the world. The course of computer evolution, starting from vacuum tube computer, through the transistor computer, till the micro-computer possessing integrated circuit, people is capable of making use of computer to engage in complicated data processing and mathematical operation in great amount and at high speed. What is more, they can also execute these works by the multiplex and parallel mode while maintaining high precision and reliability.

Immediately following the invention of the computer, its subordinate peripherals such as keyboard, mouse, printer, scanner etc. that provide ever-convenient daily life for the human being are produced accordingly. Among them, for the sake of making computer operation even more easy and convenient to substitute the elaborate commands of the keyboard, the mouse plays an important role nowadays. The mouse can be classified into track-ball type and optical type of mouse. The working principle of the track-ball type of mouse is to make use of the track-ball positioned at its bottom to drive a pivot to rotate, and accordingly drive a resister. The resistance variation of the resister generates a displacement signal that, through the processing of the computer, makes the cursor on the display screen move here-and-there. As for the technical principle of the optical mouse, it makes use of Light Emitting Diode (LED) to irradiate light beam on a plane and receive the image transmitted back within a certain time for determining how much the distance the mouse moves. An alternative is to equip a small camera inside to read in a number of images per second. Afterwards, it makes use of the light beam irradiated by the LED to clarify the images, and finally compare the relative location of the former and latter images to acquire the movement of the mouse.

Owing to the great amount of cables connected between the computer and its peripherals, people develop a wireless mouse. The wireless mouse normally includes a mouse's main-body and a receiver, wherein the receiver that normally stretching out a short wire to facilitate signal receiving is plugged in a USB joint, and the mouse's main-body normally employs two pieces of no. 3 or no. 4 battery. When it comes to turning on and operating the wireless mouse, the mouse's main-body is capable of transmitting electromagnetic wave with respect to the receiver (a blue-bud type is recommended for the technique of transmitting steady electromagnetic wave) or infra-red (a majority of them belongs to this type). The receiver then is capable of transferring the signal received into the signal of a general mouse, thereby the wireless mouse can manipulate the computer as the general mouse can do.

However, although the above-mentioned wireless mouse is not limited by the space, oftentimes the user needs to switch around manually. In addition, the fact that the user frequently forget to turn off the power supply of the mouse while he or she leaves results in insufficient power for the follow-up usage. What is more, for those users employing charging-type battery, it is inconvenient for the users to manually contact to recharge the battery when they find out that the power is insufficient. The situation becomes more serious for those users who frequently use the computer (for instance, for those users playing around video game constantly - - - etc.) and who need to frequently change the battery. This situation is very inconvenient for these users. Furthermore, the fact that the power is unable to maintain constantly will affect the added-on functions.

Therefore, it has been an urgent plan and improvement project for the designers to resolve above-mentioned problems.

### SUMMARY OF THE INVENTION

In light of above-mentioned demerits of the prior art, the invention provides a charging device and its charging method of self-moving type of mouse that aims to ameliorate at least some of the demerits of the prior art or to provide a useful alternative.

The primary objective of the invention is to provide a charging device and its charging method of self-moving type of mouse that is capable of automatically searching for a charging device to perform battery charging. It is capable of achieving the efficacy of preventing the wireless mouse from being frequently insufficient in power supply that is inconvenient in the availability of use.

The secondary objective of the invention is to provide a charging device and its charging method of self-moving type of mouse that is capable of providing battery charging without manual contact to achieve the efficacy of conveniently using the wireless mouse.

The other objective of the invention is to provide a charging device and its charging method of self-moving type of mouse that it is capable of receiving the required information by remote-control transmission, or directly moving on the plane to achieve the efficacy of increasing the pleasing, lively, and interesting computer peripherals.

The another objective of the invention is to provide a charging device and its charging method of self-moving type of mouse that it is capable of providing the use of other electronic products to achieve the efficacy of environmental protection by reducing the number of electrical appliance.

The further objective of the invention is to provide a charging device and its charging method of self-moving type of mouse that it is capable of replacing the disposable dry battery to achieve the efficacy of reducing the contaminated source.

In order to achieve above-mentioned objectives, the invention provides a charging device of self-moving type of mouse that includes a charging device and a wireless mouse. The charging device has at least a power output portion that is capable of outputting a charging power source. The wireless mouse further includes a case, a moving portion, and a transceiving portion. The case has a base and a displacement-detecting portion connected to the base. The moving portion being hidden in the case is capable of stretching out of the base. The transceiving portion being positioned on the case is connected to a charging battery and is capable of performing a matching connection to the power output portion to make the charging power source connect to the charging battery. Among them, the wireless mouse is capable of selecting to rest on a plane and performing to acquire a displacement signal with respect to the plane by the use of the displacement-detecting portion. The wireless mouse is also capable of performing action on the moving portion to make the wireless mouse perform a number of sets of predetermined displacement motion on the plane until the transceiving portion performs matching connection to the power output portion.

In order to achieve above-mentioned objectives, the invention provides a charging method of self-moving type of mouse including the following steps. Step (a): Providing a wireless mouse and a charging device, wherein the wireless mouse comprises a base, a displacement-detecting portion positioned on the base, a moving portion capable of stretching out of the base, and a transceiving portion connected to a charging battery. Step (b): Placing the wireless mouse and the charging device on a plane. Step (c): Having the displacement-detecting portion detect whether the wireless mouse is in action or not. Step (d): If the wireless mouse is in action, then, after the displacement-detecting portion acquires a displacement signal with respect to the plane, repeat Step (c); after the wireless mouse stops action for a predetermined time, let the moving portion stretch out of the base. Step (e): Having the moving portion in action, and let the wireless mouse perform a number of sets of predetermined displacement motion. Step (f): The wireless mouse moves to the charging device. Step (g): The transceiving portion (15) performs matching connection with the charging device; Step (h): Performing charging to the charging battery.

Accomplishment of this and other objectives of the invention will become apparent from the following description and its accompanying drawings of which:

### BRIEF DESCRIPTION OF THE DRAWINGS

FIG. 1 is a pictorial, schematic, structural view of charging device for self-moving type of mouse of the invention.

FIG. 2 is a bottom, schematic, structural view of the preferred embodiment of the wireless mouse device of the invention.

FIG. 3 is a schematic flow chart of the preferred embodiment of the charging method of the self-moving type of mouse of the invention.

### DETAILED DESCRIPTION OF THE PREFERRED EMBODIMENT

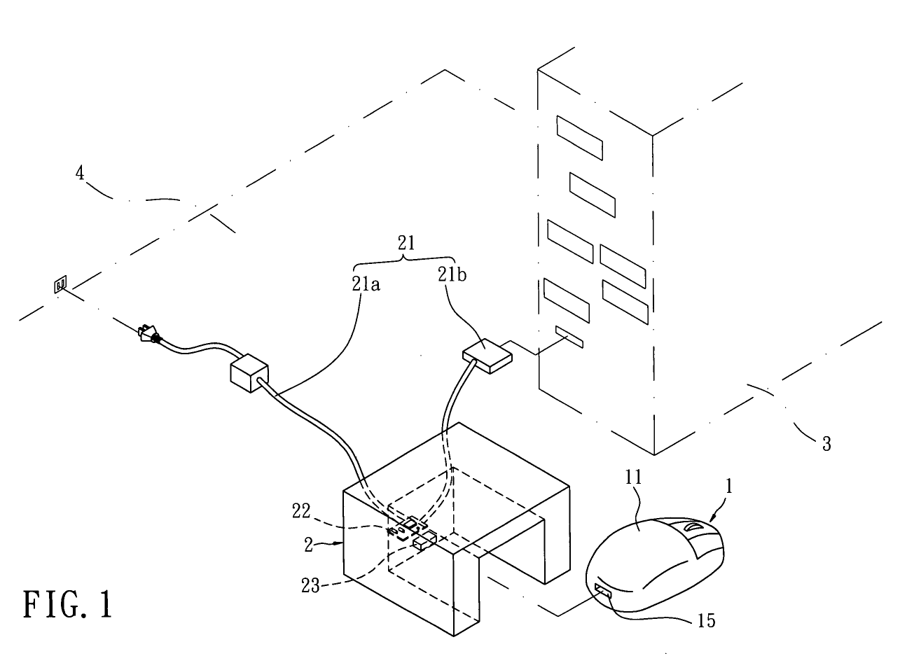

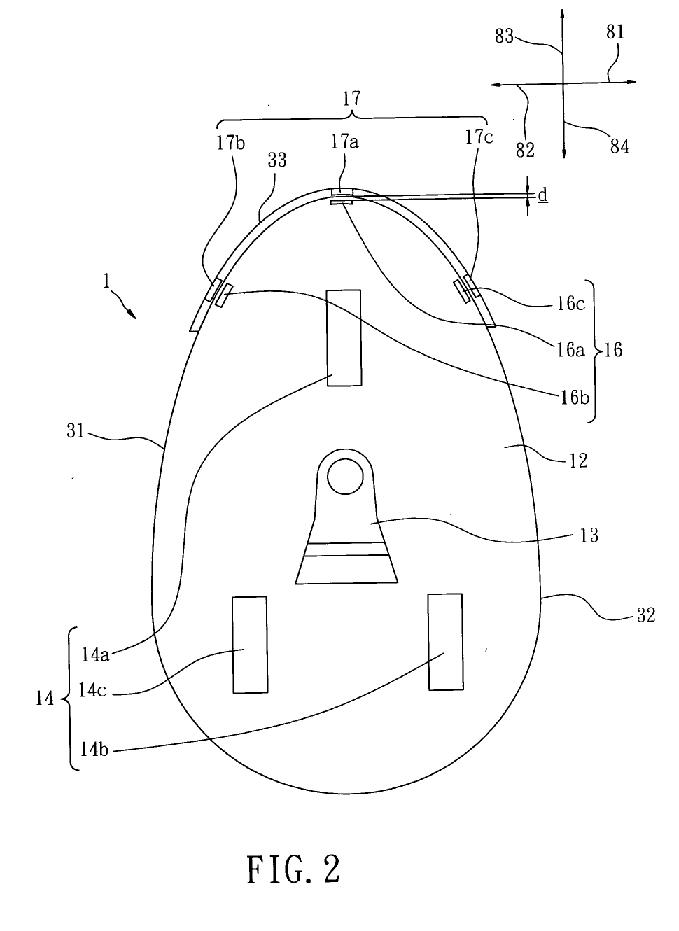

FIG. 1 is a pictorial, schematic, structural view of charging device for self-moving type of mouse of the invention, and FIG. 2 is a bottom, schematic, structural view of the preferred embodiment of the wireless mouse device of the invention. As shown in FIG. 1 and FIG. 2, the charging device of self-moving type of mouse includes a wireless mouse (1) and a charging device (2). The charging device (2) further includes a number of power input portions (21), a transferring circuit (22), and at least a power output portion (23). The power input portion (21) can provide an input power source to transfer by the transferring circuit (22) and output a charging power source by the power output portion (23). In a preferred embodiment of the invention, the power input portion (21) can be either an AC/DC exchanging type of power supply (21a) or a USB joint (21b) capable of connecting to a host computer (3). When it comes to turning on the host computer (3), the transferring circuit (22) is capable of selecting to receive the direct current provided by the USB joint (21b). While as the host computer (3) is turned off, the transferring circuit (22) can switch to select receiving the direct current transferred by alternate current source provided by AC/DC exchanging type of power supply (21a). Therefore, the transferring circuit (22) is capable of selecting one of a number of power input portions (21) to perform the transferring of the input power source into the charging power source that is available to use.

The wireless mouse (1) further includes a case (11), a moving portion (14), and a transceiving portion (15). The case (11) has a base (12) and a displacement-detecting portion (13). The displacement detecting portion (13) being positioned at the based (12) is connected thereto. As the wireless mouse (1) selects to rest on a plane (4), the displacement-detecting portion (13) is capable of acquiring a displacement signal with respect to that plane (4). This is the technical principle of an optical mouse that makes use of LED (Light Emitting Diode) to irradiate the light beam on the plane (4) and to receive the image transmitted back within a certain time for determining what distance the wireless mouse (1) has moved. Another technique of an optical mouse is to equip a small camera inside in order to read in a number of images per second first, then, make use of the light emitted from the LED to clarify the images. Finally, the movement of the wireless mouse (1) is recognized by comparing the relative locations of the former and the later images. It is not necessary to depict more than what is necessary here since these are techniques of the prior art.

The wireless mouse (1) also includes a switching portion (not shown in the Figure) connecting to the moving portion (14) and having a timer in which the moving portion (14) is hidden inside the case (11) underneath the bottom surface of the base (12). In the preferred embodiment of the invention, the moving portion (14) is the one that has a guiding wheel (14a) at the front portion of the wireless mouse (1), a first driving wheel (14b) and a second driving wheel (14c) near a first side (33) and a second side (34) respectively of the wireless mouse (1). In normal service condition, the moving portion (14) is hidden inside the case (11), but once the wireless mouse (1) is in idle condition, the moving portion (14) is capable of stretching out to contact the plane (4) in order to search for the charging device (2). That is, when the wireless mouse (1) is not in use, then, after the timer detects to find out that the displacement-detecting portion (13) stops action for a predetermined short period of time, the timer is capable of providing a signal to the switching portion. The signal is to perform action to make the moving portion (14) stretch out of the base (12) of the case (11). The stretching out of the moving portion (14) contacts the surface of the plane (4) and make the first driving wheel (14b) and the second driving wheel (14c) perform action, thereby, make the wireless mouse (1) proceed a third displacement motion (83).

The wireless mouse (1) further includes an induction portion (16) and a number of actuating portions (17). The induction portion (16) having a first induction portion (16b) and second induction portion (16c) and a third induction portion (16a) is positioned at the edge of the base (12) and is kept a distance “d” away from the outer edge of the case (11). To facilitate the following description, we define a leading edge (33), the first side (31), and the second side (32) for wireless mouse (1) in FIG. 2. The induction portion (16) being electrically connected to the moving portion (14) is an optical detector capable of detecting whether the outer edge of the case (11) is within the range of the plane (4) or not. Whenever the third induction portion (16a) at the center is unable to receive the reflection signal, it is the indication that the leading edge (31) of the wireless mouse (1) has already off the plane (4). At this moment, the first driving wheel (14b) and the second driving wheel (14c) perform action to make the wireless mouse (1) move a distance (around 20 mm) in a the direction of a fourth displacement motion (84), and afterward, perform a first displacement motion (81) or a second displacement motion (82). However, when the first induction portion (16b) at the first side (31) is unable to receive the reflection signal, it is the indication that the first side (31) of the wireless mouse (1) has already off the plane (4). At this moment, the first driving wheel (14b) stops while the second driving wheel (14c) is still moving making the wireless mouse (1) proceed in the direction of the first displacement motion (81). Likewise, when the second induction portion (16c) at the second side (32) is unable to receive the reflection signal, it is the indication that the second side (32) of the wireless mouse (1) has already off the plane (4). At this moment, the second driving wheel (14c) stops while the first driving wheel (14b) is still moving making the wireless mouse (1) proceed in the direction of the second displacement motion (82).

What is more, same as the induction portion (16), a number of actuating portions (17) including a third actuating portion (17a), a first actuating portion (17b), and a second actuating portion (17c) are all optical detectors too, and certainly are capable of generating the same effect, and can be piezo-electric switches too. The principle of action is the same as mentioned above. That is, as the first actuating portion (17b) at the first side (31) touches a obstacle, the first driving wheel (14b) stops while the second driving wheel (14c) is still moving making the wireless mouse (1) proceed in the direction of the first displacement motion (81) and vice versa. Those persons skilled in art can perform the design variation of the structure or element such as these kinds of actuating portion (17) and induction portion (16) without departing from the basic principle of the invention as well as the spirit and range of the invention. Therefore, it is not necessary to depict more than what is necessary here.

The transceiving portion (15) being positioned at the case (11) is electrically connected to a charging battery (not shown in the Figure). After the wireless mouse (1) on the plane (4) performs a number of sets of displacement motion, the wireless mouse (1) is capable of automatically escaping the obstacles and making the transceiving portion (15) perform matching connection to the power output portion (23) in accordance with the guidance of the wireless signal transmitted by the charging device (2). In this way, the charging power source is capable of performing electric charging with respect to the charging battery.

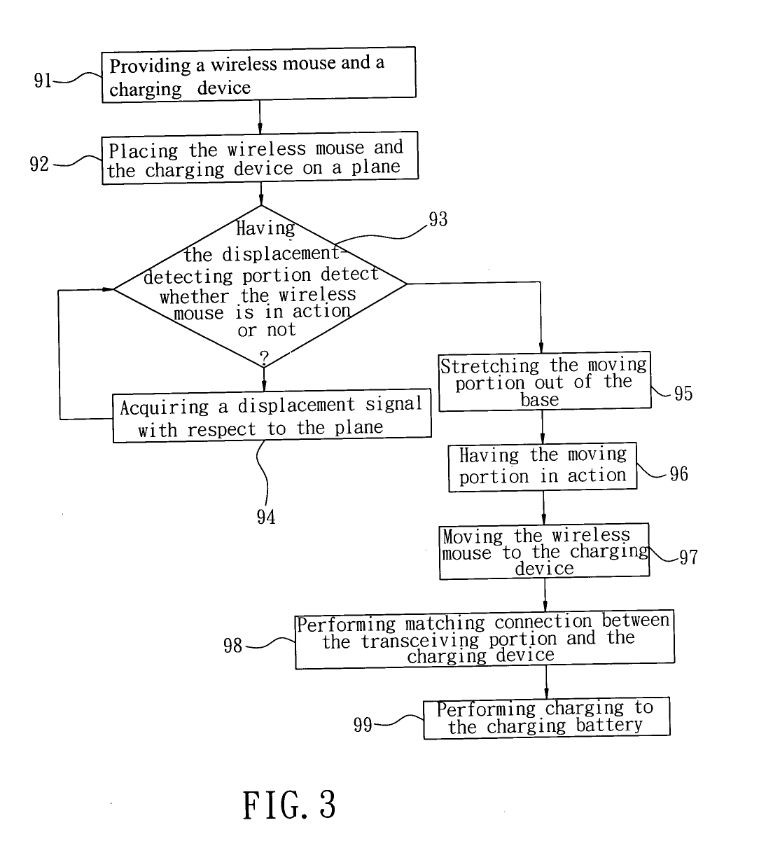

FIG. 3 is a schematic flow chart of the preferred embodiment of the charging method of the self-moving type of mouse of the invention. As shown in FIG. 3, the electric charging method of the self-moving type of mouse of the invention includes the following steps:

Step (a): providing the above-mentioned charging device (2) of the self-moving type of mouse that includes a wireless mouse (1) and a charging device (2). [Block 91]

Step (b): Placing the wireless mouse (1) and the charging device (2) on a plane (4). [Block 92]

Step (c): Having the displacement-detecting portion (13) detect whether the wireless mouse (1) is in action or not? [Block 93]

Step (d): If the wireless mouse (1) is in action, then, after the displacement-detecting portion (13) acquires a displacement signal with respect to the plane (4) [Block 94], repeat Step (c); after the wireless mouse (1) stops action for a predetermined short period of time, let the moving portion (14) stretch out of the base (12) [Block 95]

Step (e): Having the moving portion (14) in action [Block 96], and let the wireless mouse (1) perform a number of sets of predetermined displacement motion. At first, detect by the use of the induction portion (16) to find out if the outer edge of the case (11) is within the range of the plane (4)?; if it is, the wireless mouse (1) perform a predetermined first displacement motion (81); if it is not, the wireless mouse (1) perform a predetermined second displacement motion (82). In the meantime, detect if there is an obstacle?; if there is one, exert on one of a number of actuating portion (17) through collision, and the wireless mouse (1) selects one of a number of corresponding displacement motions.

Step (f): The wireless mouse (1) moves to the charging device (2). [Block 97]

Step (g): The transceiving portion (15) performs matching connection with the charging device (2) [Block 98]. At this moment, the transferring circuit (22) detects one of a number of power input portions (21) to find out if there is any input power source?; if there is one, the power is output by the power output portion (23) to the transceiving portion (15); if there is none, select another power input portions (21) and repeat the steps to perform detecting work.

Step (h): Performing charging to the charging battery. [Block 99]

It will become apparent to those people skilled in art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A charging device of self-moving type of mouse comprising:
a charging device having at least a power output portion that is capable of outputting a charging power source;
a. wireless mouse further comprising:
a case having a base and a displacement-detecting portion, the displacement-detecting portion is connected to the base;
a moving portion hidden in the case and is capable of stretching out of the base; and
a transceiving portion being positioned on the case and connected to a charging battery, the transceiving portion can have a matching connection to the power output portion to make the charging power source connect to the charging battery;
wherein the wireless mouse is capable of selecting either resting on a plane and performing to acquire a displacement signal with respect to the plane by the use of the displacement-detecting portion, or performing action on the moving portion to make the wireless mouse perform a number of sets of predetermined displacement motion on the plane until the transceiving portion performs matching connection to the power output portion.

2. The charging device of self-moving type of mouse as claimed in claim 1, wherein the charging device further comprises a number of power input portions that are capable of providing an input power source.

3. The charging device of self-moving type of mouse as claimed in claim 2, wherein the charging device further comprises a transferring circuit that is capable of transferring the input power source into the charging power source that is available for use.

4. The charging device of self-moving type of mouse as claimed in claim 3, wherein the transferring circuit is capable of selecting one of a number of power input portions to perform transferring work.

5. The charging device of self-moving type of mouse as claimed in claim 1, wherein the wireless mouse further comprises a switching portion that being connected to the moving portion is capable of providing a signal to make the moving portion stretch out of the base.

6. The charging device of self-moving type of mouse as claimed in claim 5, wherein the switching portion further comprises a timer that is capable of performing a detection to find out that the displacement-detecting portion stops action for a predetermined time, and is capable of providing the signal to the switching portion

7. The charging device of self-moving type of mouse as claimed in claim 1, wherein the wireless mouse further comprises:
an induction portion positioned on the base and kept a distance “d” from the outer edge of the case, and the induction portion being electrically connected to moving portion is capable of detecting whether the outer edge of the case is within the range of the plane or not in order to perform a predetermined displacement motion; and
a number of actuating portions being positioned at the outer edge of the case and electrically connected to the moving portion, the actuating portions being one-to-one corresponding to the wireless mouse is capable of performing a number of sets of the displacement motion.

8. A charging method of self-moving type of mouse comprising the following steps:
(a) providing a wireless mouse and a charging device, wherein the wireless mouse comprises a base, a displacement-detecting portion positioned on the base, a moving portion capable of stretching out of the base, and a transceiving portion connected to a charging battery;
(b) Placing the wireless mouse and the charging device on a plane;
(c) Having the displacement-detecting portion detect whether the wireless mouse is in action or not;
(d) If the wireless mouse is in action, then, after the displacement-detecting portion acquires a displacement signal with respect to the plane, repeat Step (c); after the wireless mouse stops action for a predetermined period of time, let the moving portion stretch out of the base;
(e) Having the moving portion in action, and let the wireless mouse perform a number of sets of predetermined displacement motion;
(f) The wireless mouse moves to the charging device;
(g) The transceiving portion performs matching connection with the charging device;
(h) Performing charging to the charging battery.

9. The charging method of self-moving type of mouse as claimed in claim 8, wherein the predetermined time in step (e) is based on a timer.

10. The charging method of self-moving type of mouse as claimed in claim 8, wherein the wireless mouse in step (a) further comprises:
a induction portion disposed on the base and kept a distance “d” from the outer edge of the case, and the induction portion is electrically connected to the moving portion; and
a number of actuating portions disposed at the outer edge of the case and being electrically connected to the moving portion, and the actuating portions are one-to-one corresponding to a number of sets of the displacement motion performed by the wireless mouse.

11. The charging method of self-moving type of mouse as claimed in claim 10, wherein the method after step (e) further comprise the following steps:
(e1) The induction portion detects if the outer edge of the case is within the range of the plane or not;
(e2) If the outer edge of the case is within the range of the plane, the wireless mouse performs a predetermined first displacement motion while if the outer edge of the case is not within the range of the plane, the wireless mouse performs a predetermined second displacement motion.

12. The charging method of self-moving type of mouse as claimed in claim 10, wherein the method after step (e) further comprise the following steps:
(e3) Exerting force on one of a number of actuating portions, and the wireless mouse selects the corresponding one of a number of sets of predetermined displacement motion.

13. The charging method of self-moving type of mouse as claimed in claim 8, wherein the charging device in step (a) further comprises a transferring circuit that is capable of selecting one of a number of power input portions to provide an input power source that is then transferred into the charging power source available for use and is output by at least a power output portion.

14. The charging method of self-moving type of mouse as claimed in claim 13, wherein the method after step (g) further comprise the following steps:
(g1) The transferring circuit detects one of a number of power input portion to find out if it has the input power source?;
(g2) If it has the input power source, outputting the power output portion to the transceiving portion; if it does not have the input power source, then selects another power input portion and repeat step (g1).
